(19) United States
(12) Patent Application Publication
(10) Pub. No.: US 2025/0298697 A1
(43) Pub. Date: Sep. 25, 2025

(54) BACKUP TECHNIQUES FOR NON-RELATIONAL METADATA

(71) Applicant: Rubrik, Inc., Palo Alto, CA (US)

(72) Inventors: Pragyan Chakraborty, Bengaluru (IN); Rajesh Kumar Jaiswal, Bengaluru (IN); Dharma Teja Bankuru, Bengaluru (IN); Prateek Pandey, Bengaluru (IN)

(21) Appl. No.: 18/616,054

(22) Filed: Mar. 25, 2024

(51) Int. Cl. G06F 11/14

(52) U.S. Cl. CPC G06F 11/1451; G06F 11/1464; G06F 11/1466; G06F 11/1469; G06F 2201/80; G06F 2201/835

(57) ABSTRACT

Methods, systems, and devices for data management are described. A data management system (DMS) may copy, at a first time, metadata from a first storage location to a second storage location. The metadata may be stored in a non-relational storage format and may include information associated with backup data stored at the DMS. The DMS may execute applications to obtain second backup data. The applications may generate additional metadata associated with the second backup data after the first time. The DMS may store, in a temporary storage location, incremental metadata changes associated with changes to the metadata since the first time based on the additional metadata generated by the applications. The DMS may copy, at a second time, the incremental metadata changes from the temporary storage location to the second storage location. The incremental metadata changes may be stored with a timestamp that indicates the second time.

### FIELD OF TECHNOLOGY

The present disclosure relates generally to data management, including techniques for backup techniques for non-relational metadata.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports backup techniques for non-relational metadata in accordance with aspects of the present disclosure.

FIG. 2 shows an example of a computing environment that supports backup techniques for non-relational metadata in accordance with aspects of the present disclosure.

FIG. 3 shows an example of a process flow that supports backup techniques for non-relational metadata in accordance with aspects of the present disclosure.

FIG. 4 shows a block diagram of an apparatus that supports backup techniques for non-relational metadata in accordance with aspects of the present disclosure.

FIG. 5 shows a block diagram of a metadata backup manager that supports backup techniques for non-relational metadata in accordance with aspects of the present disclosure.

FIG. 6 shows a diagram of a system including a device that supports backup techniques for non-relational metadata in accordance with aspects of the present disclosure.

FIGS. 7 through 9 show flowcharts illustrating methods that support backup techniques for non-relational metadata in accordance with aspects of the present disclosure.

### DETAILED DESCRIPTION

A data management system (DMS) may backup client data. The DMS may store backed up data in a first storage location (e.g., a first cloud environment), using a first storage format, or both and may store metadata associated with the data in a second storage location, using a second storage format, or both. The second format for storing the metadata may be a non-relational data format, such as a non-structured query language (NoSQL) format, or some other type of non-relational storage format. For example, the metadata may be stored as entries each indexed by a pair of a row key and a partition key and the storage may not be associated with schemas or other relational database structures. The DMS may utilize the metadata to access and retrieve the backed-up data. For example, to restore the client's backed-up data, the DMS may first access and use the corresponding metadata to then obtain the correct data for restoration. In some systems, the metadata may not be backed up (e.g., there may be a single instance of the metadata). If the metadata becomes corrupt or otherwise inaccessible, the backups of client data may also be unrecoverable. Techniques for backing up the non-relational metadata while maintaining performance of backups and other operations by the DMS may improve security and reliability.

Techniques, systems, and devices described herein provide for a DMS to obtain relatively frequent backups of metadata stored in a non-relational format without quiescing database applications executed by the DMS. That is, the applications may continue to execute while the backups of the metadata are obtained. The DMS may obtain a full backup of all of the stored metadata periodically (e.g., every 30 days, or at some other frequency) by copying the metadata from a first storage location (e.g., a metadata table in a first cloud environment) to a second storage location for storing the metadata backups. In between full backups, the DMS may obtain incremental backups of the metadata. For example, as applications that execute at the DMS (e.g., compute instances) continue to obtain backups of client data, the applications may generate additional metadata in the process, thereby changing the metadata relatively frequently. To keep track of the changes, the DMS may maintain, in a temporary storage location, change logs that represent the changes. The DMS may copy the changes from the change logs to the second storage location in which the full backups of the metadata are stored. The DMS may delete the temporary change logs after the incremental changes are copied. Thus, the DMS may maintain near-continuous backups of all changes to the metadata without quiescing the backup applications (e.g., or other applications that execute at the DMS). The DMS may store the incremental and full backups in a string table storage format, where a timestamp of each backup may be a key to the string table. The DMS may restore a version of the metadata at a timestamp, T, from the second storage location by identifying corresponding incremental and/or full backups that are indexed by timestamps up to and including the requested timestamp, T.

In some examples, multiple applications at the DMS may be obtaining backups of client data and/or analyzing backed up data simultaneously, such that metadata may be generated by multiple different sources and written to a single non-relational storage location. If the clocks used by the multiple applications are not synchronized with one another, incremental changes to the metadata may be written and stored in an out-of-order fashion. Techniques described herein provide for synchronization of the timestamps used across multiple backup applications with a source timestamp to ensure ordered and consistent storage of incremental changes. The DMS described herein may thereby backup non-relational metadata without quiescing applications and with improved time calibration techniques, such that the DMS may recover the metadata to any point-in-time, which may improve system reliability.

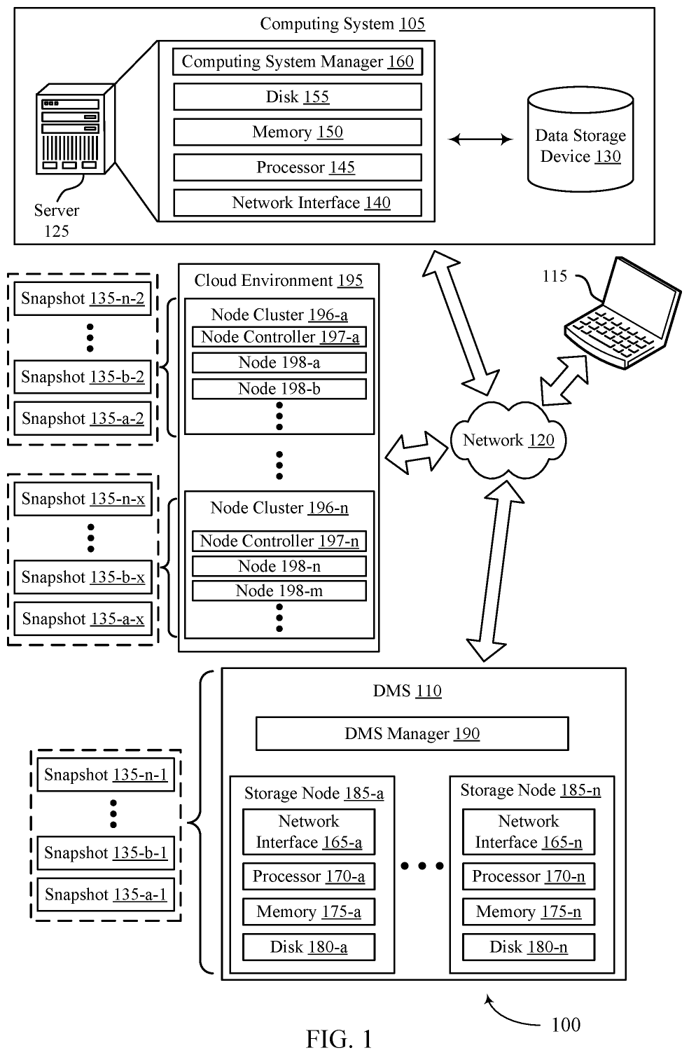

FIG. 1 illustrates an example of a computing environment 100 that supports backup techniques for non-relational metadata in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof.

The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices.

The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

The DMS 110 may generate and store metadata associated with the operations and data managed by the DMS 110. The metadata may be stored in the cloud environment 195 or some other location that is the same as or different than a storage location for corresponding snapshots 135 obtained by the DMS 110. In some examples, the DMS 110 may store backup data in a first format and may store the metadata in a second format. The second format for storing the metadata may be a non-relational data format, such as a NoSQL format, or some other type of non-relational storage format. For example, the metadata may be stored as entries each indexed by a pair of a row key and a partition key and the storage may not be associated with schemas or other relational database structures. The DMS 110 may utilize the metadata to access and retrieve the backed-up data. For example, to restore the client's backed-up data, the DMS 110 may first access and use the corresponding metadata to then obtain the correct data for restoration. In some systems, the metadata may not be backed up (e.g., there may be a single instance of the metadata). If the metadata becomes corrupt or otherwise inaccessible, the backups of client data may also be unrecoverable. Techniques for backing up the non-relational metadata while maintaining performance of backups and other operations by the DMS 110 may improve security and reliability.

Techniques, systems, and devices described herein provide for the DMS 110 to obtain relatively frequent backups of metadata stored in a non-relational format without quiescing database applications executed by the DMS 110. That is, the applications may continue to execute while the backups of the metadata are obtained. The applications may represent examples of compute instances associated with the DMS 110 (e.g., various applications executed across the one or more storage nodes 185, among other examples). The DMS 110 may obtain a full backup of all of the stored metadata periodically (e.g., every 30 days, or at some other frequency) by copying the metadata from a first storage location (e.g., a metadata table in the cloud environment 195) to a second storage location for storing the metadata backups (e.g., another cloud environment, a computing system 105, or some other location). In between full metadata backups, the DMS 110 may obtain incremental backups of the metadata. For example, as applications that execute at the DMS 110 (e.g., compute instances) continue to obtain backups of client data, the applications may generate additional metadata in the process, thereby changing the metadata relatively frequently. To keep track of the changes, the DMS 110 may maintain, in a temporary storage location, change logs that represent the changes. The DMS 110 may copy the changes from the change logs to the second storage location in which the full backups of the metadata are stored. The DMS 110 may delete the temporary change logs after the incremental changes are copied. Thus, the DMS 110 may maintain near-continuous backups of all changes to the metadata without quiescing the backup applications (e.g., or other applications that execute at the DMS 110). The DMS 110 may store the incremental and full backups in a string table storage format, where a timestamp of each backup may be a key to the string table. The DMS 110 may restore a version of the metadata at a timestamp, T, from the second storage location by identifying corresponding incremental and/or full backups that are indexed by timestamps up to and including the requested timestamp, T.

In some examples, multiple applications at the DMS 110 may be obtaining backups of client data and/or analyzing backed up data simultaneously, such that metadata may be generated by multiple different sources and written to a single non-relational storage location. If the clocks used by the multiple applications are not synchronized with one another, incremental changes to the metadata may be written and stored in an out-of-order fashion. Techniques described herein provide for synchronization of the timestamps used across multiple backup applications with a source timestamp to ensure ordered and consistent storage of incremental changes. The DMS 110 described herein may thereby backup non-relational metadata without quiescing applications and with improved time calibration techniques, such that the DMS 110 may recover the metadata to any point-in-time, which may improve system reliability.

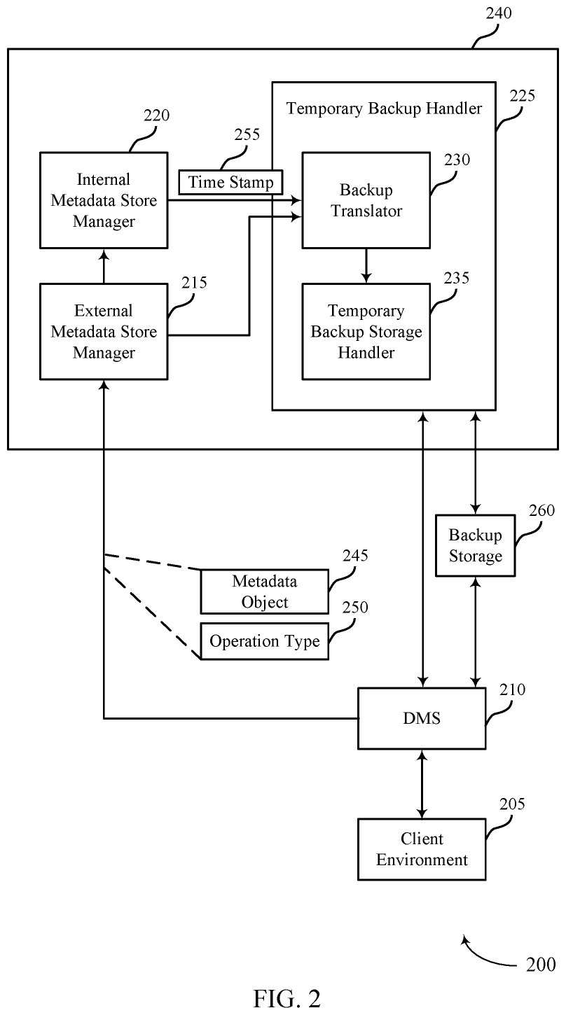

FIG. 2 shows an example of a computing environment 200 that supports backup techniques for non-relational metadata in accordance with aspects of the present disclosure. The computing environment 200 may implement or be implemented by aspects of the computing environment 100 described with reference to FIG. 1. For example, the computing environment 200 may include a DMS 210, which may represent an example of the DMS 110 described with reference to FIG. 1. The DMS 210 may manage data backup and recovery of data within a client environment 205, which may represent an example of a cloud environment 195, a computing system 105, some other type of environment or data storage location, or any combination thereof, as described with reference to FIG. 1. In this example, the DMS 210 may facilitate backup and recovery of non-relational metadata associated with the client environment 205.

The client environment 205 may be some computing environment, cloud environment, or other storage location that hosts a filesystem of client data. The data within the client environment 205 may be managed by the DMS 210, in some examples. The DMS 210 may execute one or more applications (e.g., compute instances, pods) that obtain backups of the client data in the client environment 205, among other data management operations, as described with reference to FIG. 1. The applications may execute at the DMS 210, may be facilitated by the DMS 210, may execute at one or more other locations, or any combination thereof. The DMS 210 may manage (e.g., facilitate, control) the applications.

In this example, the execution of the one or more applications may alter or modify that client data in the client environment 205. Additionally, or alternatively, the applications may analyze or backup the client data in the client environment 205. The applications may generate metadata associated with the changes to the data, the analysis of the data, the backups of the data, or any combination thereof. For example, an application may obtain a backup of client data and may generate metadata that identifies or otherwise categorizes or defines the backed up data and corresponding snapshot. The metadata may be stored in a non-relational format. For example, the metadata may be stored as entries each indexed by a pair of a row key and a partition key, and the storage of the metadata may not be associated with schemas or other relational database structures. The metadata may be a NoSQL format, or some other non-relational format, for example.

In some examples, the DMS 210 may utilize the metadata store 240 to manage and store the metadata. The metadata store 240 may include the external metadata store manager 215, the internal metadata store manager 220, some other components, or any combination thereof, which may be configured to manage and store the metadata. For example, after metadata is generated by the applications, the DMS 210 may transmit the metadata to the external metadata store manager 215 for storage. The external metadata store manager 215 may forward the metadata to the internal metadata store manager 220, and the internal metadata store manager 220 may perform operations (e.g., read and/or write operations) on the metadata objects (DAOs) based on instructions from the applications. The internal metadata store manager 220 may additionally, or alternatively, generate and return, via the external metadata store manager 215, a timestamp associated with the corresponding operation each time the internal metadata store manager 220 performs a metadata write operation (e.g., insert, delete, update, or the like). The internal metadata store manager 220 may store the metadata or may update metadata stored at a different location, such as some other database or server coupled with the internal metadata store manager 220. The internal metadata store manager 220 and the external metadata store manager 215 may, in some examples, be a same component (e.g., a same group of circuitry, controllers, processors, and the like) or different components.

The DMS 210 may utilize the metadata to access the client data in the client environment 205. For example, before the DMS 210 restores a backup of client data, the DMS 210 may first retrieve corresponding metadata from the metadata store 240. In some systems, the metadata stored by the metadata store 240 may become corrupt or otherwise inaccurate over time. For example, one or more conditions or external events may modify or corrupt the metadata. If the metadata is inaccurate, the DMS 210 may not be able to accurately or reliably access the client data.

Techniques described herein provide for the DMS 210 to facilitate backups of the metadata within the metadata store 240. The backups of the metadata may provide for the metadata to be restored in the event that the metadata becomes corrupt. For example, the DMS 210 may obtain a full backup of the metadata periodically according to a first periodicity. The DMS 210 may obtain incremental backups of the metadata according to a second periodicity that is shorter than the first periodicity, such that the DMS 210 may obtain multiple incremental backups between each full backup. One or more applications may continue to execute on the client data in the client environment 205 while the DMS 210 obtains the backups of the metadata. That is, the DMS 210 may obtain the metadata backups without quiescing applications, which may provide for improved reliability of the metadata while maintaining efficiency and throughput within the system.

The full metadata backups may be obtained by the DMS 210, in some examples. For example, the DMS 210 may make a copy of entries in metadata tables associated with the data in the client environment 205, and the DMS 210 may store the copy of the entries in the backup storage 260, which may be some storage location included in or coupled with the DMS 210, the client environment 205, the metadata store 240, or any combination thereof. The full backup may include a copy of all entries in a metadata table at a time of the full backup. For example, the DMS 210 may iterate through all entries of a metadata table at a given time. The metadata table may be stored at the DMS 210 or in some other location. In some examples, the DMS 210 may obtain separate backups for each metadata table. The first periodicity associated with the full backups may be relatively long (e.g., every 30 days, or some other periodicity) and may be configurable by a user via a user interface or some other configuration of client data.

The incremental metadata backups may be obtained by the DMS 210 using the temporary backup handler 225, in some examples. The temporary backup handler 225 may represent an example of one or more components (e.g., circuitry, logic, processors, controllers, or the like) within the metadata store 240 that may keep track of changes to metadata over time to facilitate incremental backups of the metadata without quiescing applications.

As applications execute on the client data and generate new metadata or change existing metadata, the changed metadata may be conveyed to the metadata store 240 as the metadata object(s) 245, as well as the corresponding operation types 250. For example, the DMS 210 may convey, to the external metadata store manager 215, one or more metadata objects 245 that are changed relative to previous metadata objects, and the DMS 210 may convey an indication of one or more operation types 250 associated with the one or more metadata objects 245. The operation types 250 may include, for example, a delete operation, an insert operation, or an update operation, among other examples. As described herein, the external metadata store manager 215 may forward the metadata object 245 and the corresponding operation types 250 to the internal metadata store manager 220 and the backup translator 230 within the temporary backup handler 225. The internal metadata store manager 220 may perform the requested operation to update the metadata. For example, the internal metadata store manager 220 may insert the metadata object 245, delete the metadata object 245, or the like. The internal metadata store manager 220 may generate a corresponding timestamp 255 associated with the operation, which the internal metadata store manager 220 may forward to the backup translator 230.

The backup translator 230 may receive a metadata object 245 and operation type 250 from the external metadata store manager 215 and the corresponding timestamp 255 from the internal metadata store manager 220. The backup translator 230 may create a temporary backup metadata object and may implement one or more methods to convert the temporary backup metadata object to and from a metadata object. The backup translator 230 may transfer the temporary backup metadata object along with the corresponding timestamp 255 to the temporary backup storage handler 235. The temporary backup storage handler 235 may include or be coupled with a temporary storage location and may facilitate storage of the temporary backup metadata objects from the backup translator 230 within the temporary storage location.

The temporary storage location may be utilized to temporarily store incremental changes to the metadata between backups. The temporary storage location may provide for the applications to continue executing and generating changed metadata without quiescing while the DMS 210 continues to track the changes (e.g., via the temporary backup storage handler 235).

The DMS 210 may perform incremental metadata backups periodically. The periodicity for the incremental backups may be more frequent than the periodicity associated with the full backups, such that the DMS 210 may obtain one or more incremental backups between each full backup. After a full backup is obtained, any new changes to the metadata are stored in the temporary storage location as described herein. At a second time associated with the incremental backup periodicity, the incremental metadata changes are copied from the temporary storage location to the backup storage 260 (e.g., a second storage location), along with the corresponding timestamps 255. The DMS 210 may thereby facilitate an incremental backup of the metadata by copying the incremental metadata changes from the temporary storage to the backup storage 260. The incremental metadata changes may be stored with a pointer or other association to the full backup of the metadata in the backup storage 260 and a corresponding timestamp that indicates the time at which the incremental metadata changes were copied. By storing the timestamps 255 associated with each operation, the DMS 210 may support restoration from any point-in-time. In some examples, the temporary backup storage handler 235 may facilitate iteration over the backup metadata objects in the temporary storage before the timestamp associated with the incremental backup.

After the incremental backup is obtained and stored in the backup storage 260, the temporary backup storage handler 235 may delete the incremental metadata changes from the temporary storage location. The temporary storage may be cleared after each backup to improve resource utilization and increase storage capacity. Any other changes to the metadata that occur after the incremental backup and before a next incremental backup may then be written to the temporary storage location based on the temporary storage location being cleared, and the incremental backup process may repeat periodically. The backup storage 260 may thereby include a chain or log (e.g., a blob) of metadata backups, including one or more full backups and a chain of one or more incremental backups obtained between the one or more full backups. A reference time for the next timestamp at which the temporary storage is to be copied to the backup storage 260 may be based on a most recently obtained incremental snapshot in the backup storage 260 or a most recently obtained full snapshot in the backup storage 260.

The full backups may be stored in a full backup path within the backup storage 260. A key for identifying the full backups in a sorted strings table format may be a key of the entity and the value may be a marshaled entity. The incremental backups may be stored in an incremental path within the backup storage 260. A key for identifying the incremental backups in the sorted strings table format may be the key of the entity along with a timestamp of a corresponding write operation, and the value may be a marshaled entity along with an operation type. In some examples, the backups may be encrypted.

In some examples, multiple different applications may write metadata to the metadata store 240 at the same time or in overlapping time periods. Each application may execute according to its own clock, and, if two or more of the applications are not synchronized, some of the metadata may be written out-of-order, in some examples, which may reduce reliability of the metadata backups. For example, in some cases, a timestamp may be a server-returned timestamp. In such cases, the internal metadata store manager 220 may receive a timestamp from a server associated with the metadata store 240. However, the server may send timestamps for create operations, but may not send accurate timestamps for other operations, such as update and delete operations. As such, if the internal metadata store manager 220 obtains a timestamp from the server, the timestamps for some operations may not be accurate. If updates are performed on a same entity by different applications within a relatively short time period, both operations may have the same timestamp, which may be problematic when storing the backup. A more accurate timestamp may be retrieved by re-fetching the entity, but re-fetching may increase latency and complexity. In some other cases, the timestamp may be a local timestamp associated with the application. For example, the internal metadata store manager 220 may generate a timestamp locally (e.g., using a function, such as time.Now ( ) or some other timestamp retrieval function). The timestamp may correspond to a start of an operation and a first write operation may be used to calibrate a current time of a given compute resource (e.g., pod) to be used for future operations. However, if multiple compute resources are performing operations on the metadata at the same time, the calibrations may be inconsistent across the compute instances, which may result in inaccuracies in the timestamps.

Techniques for improved time calibration described herein may provide for updates to metadata tables being captured sequentially by combining the server-returned timestamp calibration with the local timestamp calibration to maintain accuracy and consistency across compute resources while reducing cost and complexity. For example, for a first write operation for the metadata, the corresponding entity may be re-fetched to obtain a server-returned timestamp. The server-returned timestamp may be used to calibrate the timestamp for the corresponding compute resource, and each compute resource may be calibrated based on use of the same server timestamp. The calibrated timestamp may be used for future operations. The timestamp may be calibrated for the operation start timestamp (e.g., not the end) so the backups for a given entity are stored in an order in which the operations were performed. The system may thereby support improved timestamp calibration to ensure consistency and reliability of the order in which the metadata is backed up.

The metadata backup techniques described herein may provide for restoration of the metadata to a given state. The metadata restoration may be performed relative to a timestamp. If any timestamp is not provided, a current time may be used. To restore the metadata to a given time, the DMS 210 may identify a most recently-obtained full backup before the given time as well as all incremental backups that depend from (e.g., occurred after) the most recently-obtained full backup and are obtained before or at the same time as the given time. The full backup and incremental backups may be stored in the backup storage 260 and may be identified by the entity and corresponding timestamps. The metadata may be restored based on the combination of the full backup and the incremental backups. The metadata may be restored to a certain time based on the calibration and storage of the timestamps 255 with the backed up metadata.

In some examples, if a single entity in the metadata (e.g., a single computing object or other resource) is restored to a given timestamp, the DMS 210 may restore a last active version of the entity before the timestamp. The DMS 210 may iterate through the incremental backups in reversed timestamp order and may check for existence of any active version of the entity in the incremental backups. If an active version is identified, the DMS 210 may restore the entity to the identified version, may stop the iteration, and may return or exit the operation. If the DMS 210 does not identify an active version in any of the incremental backups, the DMS 210 may search the full backup. If the active version is not found in the full backup, the DMS 210 may return an error and may be unable to complete the restoration.

In some examples, to restore a full metadata table, the DMS 210 may first restore the metadata table using the full backup. The DMS 210 may then patch incremental backups on top of the restored table in order of the backup timestamps. This may reduce failure as compared with restoration processes in which single entities are restored at a time and failure of a single entity results in failure of the entire restoration.

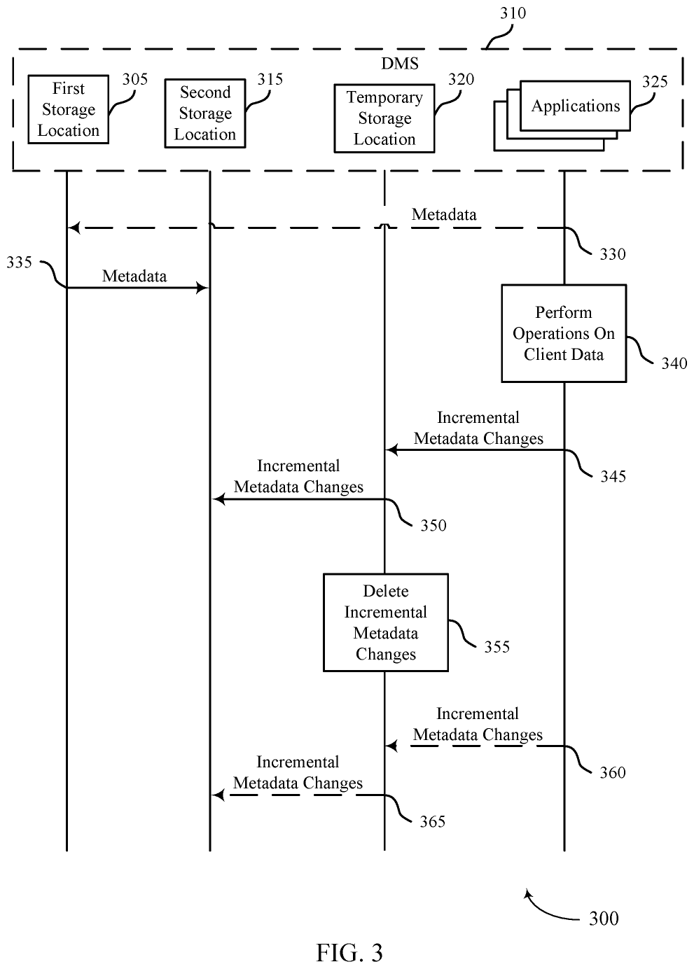

FIG. 3 shows an example of a process flow 300 that supports backup techniques for non-relational metadata in accordance with aspects of the present disclosure. The process flow 300 may implement or be implemented by aspects of FIGS. 1 and 2. For example, the process flow 300 may be implemented by DMS 310, which may represent an example of a corresponding DMS as described with reference to FIGS. 1 and 2. In this example, the DMS 310 may include, be coupled with, or otherwise be in communication with one or more components, such as the first storage location 305, the second storage location 315, the temporary storage location 320, and one or more applications 325, among other components.

The various storage locations and applications may represent examples of corresponding components as described with reference to FIG. 2. For example, the first storage location 305 may represent an example of a storage location associated with the DMS 310, the second storage location 315 may represent an example of the backup storage 260, and the temporary storage location 320 may represent an example of the temporary backup storage handler 235, or other components therein. The DMS 310 may facilitate backups of non-structured metadata generated by the applications 325 and associated with data stored in the first storage location 305. The metadata backups may utilize the temporary storage location 320 to facilitate continuous backups of the metadata without quiescing the applications 325, as described herein.

In some aspects, the operations illustrated in the process flow 300 may be performed by hardware (e.g., including circuitry, processing blocks, logic components, and other components), code (e.g., software or firmware) executed by a processor, or any combination thereof. For example, aspects of the process flow 300 may be implemented or managed by a DMS 310, a metadata backup manager 620, or some other software or application that is associated with data backup and recovery.

At 330, in some examples, the applications 325 may generate metadata that may be stored in the first storage location 305. In some examples, the applications 325 may perform one or more operations involving data stored in the first storage location 305, and the operations may generate the metadata. For example, the applications 325 may backup the data, may analyze the data, or may otherwise alter or modify the data and may generate metadata that identifies, defines, or describes the changes or analysis (e.g., information associated with backup data stored by the DMS 310). The metadata may be stored in one or more metadata tables (e.g., or other data storage structures, such as queries, lists, or the like) in the first storage location 305. Additionally, or alternatively, the metadata may be stored elsewhere, such as within a metadata store 240 as described with reference to FIG. 2, or some other location.

At 335, the DMS 310 may copy metadata from the first storage location 305 to the second storage location 315. The metadata that is copied at 335 may include a copy of all entries within a metadata table stored at the first storage location 305. For example, the DMS 310 may copy all metadata associated with backup data stored by the DMS 310. The copy of all entries in the metadata table may be referred to as a full backup. The DMS 310 may copy all entries in the metadata table to the second storage location at a first time associated with a first periodicity for obtaining full backups. In some examples, the DMS 310 may copy all entries in one or more other metadata tables at the first time or one or more other times.

At 340, the DMS 310 may facilitate execution of the one or more applications 325. For example, one or more of the applications 325 may perform operations on data in the first storage location 305. The operations may include obtaining a backup of the data, among other examples. The execution of the applications 325 may generate additional metadata. For example, the DMS 310 may continue to obtain backups of the data in the first storage location 305, and the additional metadata may be associated with the further backed-up information.

At 345, the DMS 310 may store one or more incremental metadata changes in the temporary storage location 320. Although illustrated as separate operations, it is to be understood that the applications 325 may write the metadata changes to the temporary storage location, such that the incremental metadata changes are stored in near-real-time. The incremental metadata changes may be associated with changes to the metadata in the full backup since the first time at which the full backup was obtained. By writing the incremental metadata changes generated by the applications 325 to the temporary storage location 320, the DMS 310 may continue execution of the applications 325 while monitoring the changes, which may improve efficiency.

At 350, the DMS 310 may copy the one or more incremental metadata changes from the temporary storage location 320 to the second storage location 315. The metadata that is copied at 350 may include changes to one or more entries within the metadata table. For example, the incremental metadata changes may include updates to entries previously backed-up by the DMS 310. The copy of the incremental metadata changes to the second storage location 315 may be referred to as an incremental backup. The DMS 310 may perform the incremental backup periodically, and a periodicity of the incremental backups may be shorter than a periodicity of the full backups. The DMS 310 may obtain one or more incremental backups between each full backup of the metadata. The second storage location 315 may include the full backup along with the one or more incremental backups in a backup chain, each associated with a respective timestamp. As described with reference to FIG. 2, the incremental metadata changes may be stored in the second storage location along with a timestamp that indicates the second time at which the changes were copied. Additionally, each incremental metadata change may be stored with a respective timestamp generated when the changes were stored. As described with reference to FIG. 2, the timestamp may be calibrated to ensure accuracy in the ordering of metadata generated by multiple different applications 325.

At 355, the DMS 310 may delete the incremental metadata changes from the temporary storage location 320. For example, the contents of the temporary storage location may be cleared. The temporary storage location 320 is cleared after the incremental backup is obtained to make room for storage of subsequent metadata changes.

At 360, in some examples, one or more second incremental metadata changes may be stored to the temporary storage location 320 after the temporary storage location 320 is cleared. The one or more second incremental metadata changes may include changes to the metadata that are generated by the applications 325 after the second time at which the incremental backup was obtained (e.g., at 350). The applications 325 may continue executing respective operations without stopping, which may generate the metadata changes.

At 365, in some examples, the DMS 310 may copy the one or more second incremental metadata changes from the temporary storage location 320 to the second storage location 315 as a second incremental backup. The metadata changes may be copied at a third time associated with the incremental backup periodicity and may be stored with respective timestamps in the second storage location 315. The second storage location 315 may include a chain of the full backup and the two incremental backups. The DMS 310 may subsequently delete the second incremental metadata changes from the temporary storage location 320 and may continue to obtain incremental backups in this manner. At a next full backup periodicity, the DMS 310 may copy all entries of a metadata table in the first storage location 305 to the second storage location 315, and the DMS 310 may continue to track and store incremental changes that occur after the second full backup.

The DMS 310 as described herein may thereby facilitate continuous backups of non-relational metadata. By utilizing the temporary storage location 320, the DMS 310 may maintain backups of each incremental change to the metadata and may store the backups without quiescing the applications 325, which may improve throughput and reliability of the system. Additionally, or alternatively, by calibrating timestamps across the applications using an initial server-returned timestamp for initial calibration, the DMS 310 may support improved accuracy and reliability of the backups. For example, a sequence of full and incremental backups may be obtained and stored in order, which may provide for restoration of the metadata to any given point-in-time.

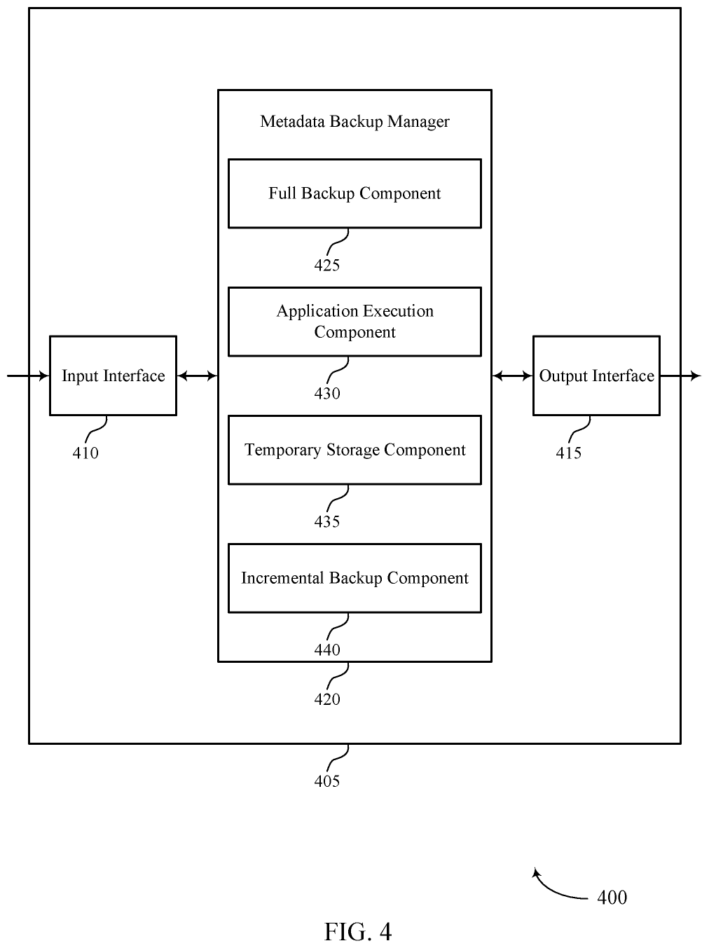

FIG. 4 shows a block diagram 400 of a system 405 that supports backup techniques for non-relational metadata in accordance with aspects of the present disclosure. In some examples, the system 405 may be an example of aspects of one or more components described with reference to FIG. 1, such as a DMS 110. The system 405 may include an input interface 410, an output interface 415, and a metadata backup manager 420. The system 405 may also include one or more processors. Each of these components may be in communication with one another (e.g., via one or more buses, communications links, communications interfaces, or any combination thereof).

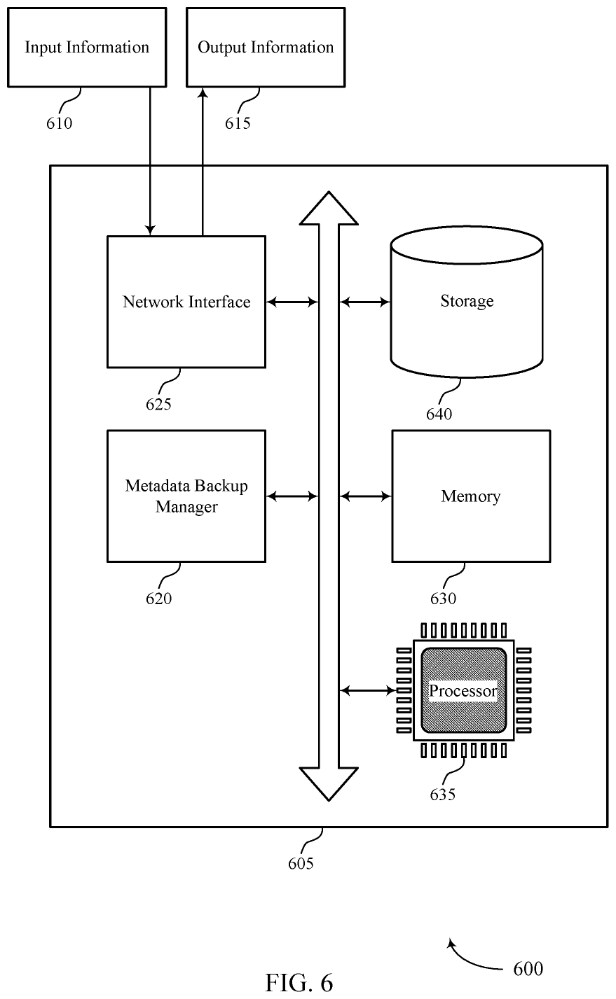

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the metadata backup manager 420 to support backup techniques for non-relational metadata. In some cases, the input interface 410 may be a component of a network interface 625 as described with reference to FIG. 6.

The output interface 415 may manage output signaling for the system 405. For example, the output interface 415 may receive signaling from other components of the system 405, such as the metadata backup manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the metadata backup manager 420 may include a full backup component 425, an application execution component 430, a temporary storage component 435, an incremental backup component 440, or any combination thereof. In some examples, the metadata backup manager 420, or various components thereof, may be configured to perform various operations (e.g., receiving, monitoring, transmitting) using or otherwise in cooperation with the input interface 410, the output interface 415, or both. For example, the metadata backup manager 420 may receive information from the input interface 410, send information to the output interface 415, or be integrated in combination with the input interface 410, the output interface 415, or both to receive information, transmit information, or perform various other operations as described herein.

The full backup component 425 may be configured as or otherwise support a means for copying, by a DMS at a first time, metadata from a first storage location to a second storage location, the metadata including information associated with backup data stored at the DMS, where the metadata is stored in accordance with a non-relational database storage format. The application execution component 430 may be configured as or otherwise support a means for executing, by the DMS, one or more applications to obtain second backup data, where the one or more applications generate additional metadata associated with the second backup data after the first time at which the metadata is copied to the second storage location. The temporary storage component 435 may be configured as or otherwise support a means for storing, in a temporary storage location, one or more incremental metadata changes, the one or more incremental metadata changes associated with changes to the metadata since the first time based on the additional metadata generated by the one or more applications. The incremental backup component 440 may be configured as or otherwise support a means for copying, at a second time, the one or more incremental metadata changes from the temporary storage location to the second storage location, where the one or more incremental metadata changes are stored with a timestamp that indicates the second time.

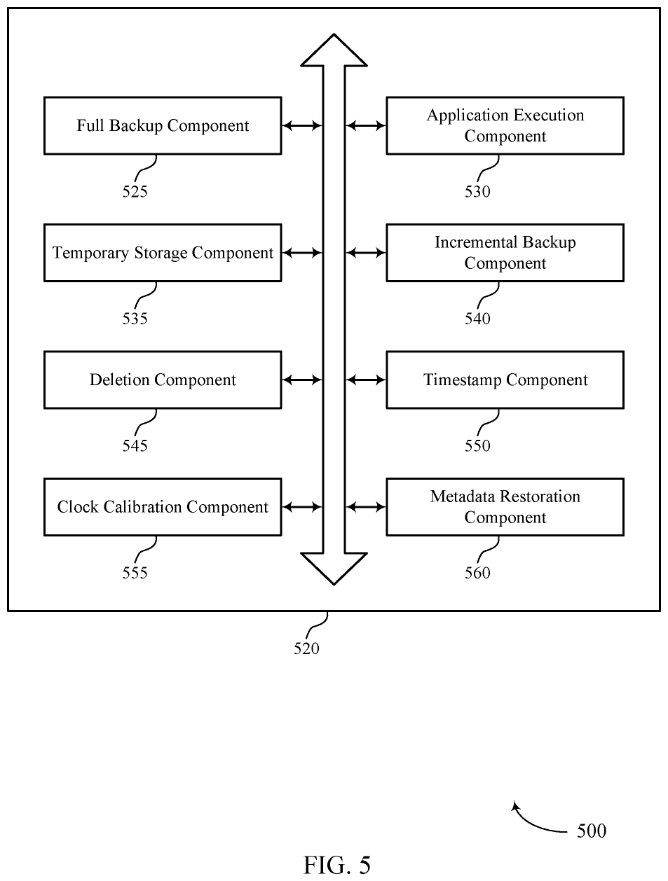

FIG. 5 shows a block diagram 500 of a metadata backup manager 520 that supports backup techniques for non-relational metadata in accordance with aspects of the present disclosure. The metadata backup manager 520 may be an example of aspects of a metadata backup manager or a metadata backup manager 420, or both, as described herein. The metadata backup manager 520, or various components thereof, may be an example of means for performing various aspects of backup techniques for non-relational metadata as described herein. For example, the metadata backup manager 520 may include a full backup component 525, an application execution component 530, a temporary storage component 535, an incremental backup component 540, a deletion component 545, a timestamp component 550, a clock calibration component 555, a metadata restoration component 560, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The full backup component 525 may be configured as or otherwise support a means for copying, by a DMS at a first time, metadata from a first storage location to a second storage location, the metadata including information associated with backup data stored at the DMS, where the metadata is stored in accordance with a non-relational database storage format. The application execution component 530 may be configured as or otherwise support a means for executing, by the DMS, one or more applications to obtain second backup data, where the one or more applications generate additional metadata associated with the second backup data after the first time at which the metadata is copied to the second storage location. The temporary storage component 535 may be configured as or otherwise support a means for storing, in a temporary storage location, one or more incremental metadata changes, the one or more incremental metadata changes associated with changes to the metadata since the first time based on the additional metadata generated by the one or more applications. The incremental backup component 540 may be configured as or otherwise support a means for copying, at a second time, the one or more incremental metadata changes from the temporary storage location to the second storage location, where the one or more incremental metadata changes are stored with a timestamp that indicates the second time.

In some examples, the deletion component 545 may be configured as or otherwise support a means for deleting, after the second time, the one or more incremental metadata changes from the temporary storage location based on copying the one or more incremental metadata changes to the second storage location.

In some examples, the temporary storage component 535 may be configured as or otherwise support a means for storing, in the temporary storage location after the one or more incremental metadata changes are deleted from the temporary storage location, one or more second incremental metadata changes, the one or more second incremental metadata changes associated with changes to the metadata after the second time and before a third time based on further execution of the one or more applications. In some examples, the incremental backup component 540 may be configured as or otherwise support a means for copying, at the third time, the one or more second incremental metadata changes from the temporary storage location to the second storage location, where the one or more second incremental metadata changes are stored with a second timestamp that indicates the third time.

In some examples, to support copying the metadata from the first storage location to the second storage location, the full backup component 525 may be configured as or otherwise support a means for obtaining a full backup of the metadata at the first time, where the first time is based on a first periodicity for full backups of the metadata.

In some examples, to support copying the one or more incremental metadata changes from the temporary storage location to the second storage location, the incremental backup component 540 may be configured as or otherwise support a means for obtaining an incremental backup of the metadata at the second time, where the second time is based on a second periodicity for incremental backups of the metadata, and where the first periodicity is greater than the second periodicity.

In some examples, the full backup of the metadata includes a backup of all entries of a first metadata table in the first storage location at the first time, and the full backup component 525 may be configured as or otherwise support a means for obtaining a second full backup of all entries of the first metadata table in the first storage location at a third time.

In some examples, the full backup of the metadata includes a backup of all entries of a first metadata table in the first storage location at the first time, and the full backup component 525 may be configured as or otherwise support a means for obtaining a second full backup of all entries of a second metadata table in the first storage location at the first time. In some examples, the full backup of the metadata includes a backup of all entries of a first metadata table in the first storage location at the first time, and the incremental backup component 540 may be configured as or otherwise support a means for obtaining a second incremental backup of the second metadata table at a third time, where the second incremental backup includes changes to the second metadata table after the first time and before the third time.

In some examples, the timestamp component 550 may be configured as or otherwise support a means for obtaining, from the first storage location, the additional metadata generated by the one or more applications and a first timestamp associated with the additional metadata, where the timestamp is based on the first timestamp. In some examples, the clock calibration component 555 may be configured as or otherwise support a means for calibrating a clock associated with the second storage location based on the first timestamp obtained from the first storage location. In some examples, the timestamp component 550 may be configured as or otherwise support a means for generating, based on the calibrated clock, one or more second timestamps for storage with one or more second incremental metadata changes performed at one or more third times.

In some examples, the timestamp component 550 may be configured as or otherwise support a means for obtaining a second timestamp associated with restoration of the metadata. In some examples, the metadata restoration component 560 may be configured as or otherwise support a means for identifying, in the second storage location, a full backup of the metadata that is associated with a third timestamp that is before the second timestamp and is closest to the second timestamp than other timestamps associated with other full backups of the metadata in the second storage location, where the full backup includes all entries associated with the metadata. In some examples, the metadata restoration component 560 may be configured as or otherwise support a means for identifying, in the second storage location, one or more incremental backups of the metadata associated with respective timestamps that are after the third timestamp of the full backup and before the second timestamp, where the one or more incremental backups include changes to the metadata since the full backup. In some examples, the metadata restoration component 560 may be configured as or otherwise support a means for restoring the metadata to a state of the metadata at the second timestamp based on the full backup of the metadata and the one or more incremental backups of the metadata.

In some examples, the application execution component 530 may be configured as or otherwise support a means for executing, by the DMS while storing the one or more incremental metadata changes in the temporary storage location and copying the one or more incremental metadata changes to the second storage location, the one or more applications to obtain the second backup data, where the temporary storage location provides for uninterrupted execution of the one or more applications during metadata backup operations.

In some examples, the metadata and the one or more incremental metadata changes are stored in a sorted strings table format in the second storage location, the sorted strings table format indexed by respective timestamps associated with each entry of the sorted strings table format.

In some examples, the metadata includes non-structured query language metadata.

FIG. 6 shows a block diagram 600 of a system 605 that supports backup techniques for non-relational metadata in accordance with aspects of the present disclosure. The system 605 may be an example of or include components of a system 405 as described herein. The system 605 may include components for data management, including components such as a metadata backup manager 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting backup techniques for non-relational metadata). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the metadata backup manager 620 may be configured as or otherwise support a means for copying, by a DMS at a first time, metadata from a first storage location to a second storage location, the metadata including information associated with backup data stored at the DMS, where the metadata is stored in accordance with a non-relational database storage format. The metadata backup manager 620 may be configured as or otherwise support a means for executing, by the DMS, one or more applications to obtain second backup data, where the one or more applications generate additional metadata associated with the second backup data after the first time at which the metadata is copied to the second storage location. The metadata backup manager 620 may be configured as or otherwise support a means for storing, in a temporary storage location, one or more incremental metadata changes, the one or more incremental metadata changes associated with changes to the metadata since the first time based on the additional metadata generated by the one or more applications. The metadata backup manager 620 may be configured as or otherwise support a means for copying, at a second time, the one or more incremental metadata changes from the temporary storage location to the second storage location, where the one or more incremental metadata changes being stored with a timestamp that indicates the second time.

By including or configuring the metadata backup manager 620 in accordance with examples as described herein, the system 605 may support techniques for backup techniques for non-relational metadata, which may provide one or more benefits such as, for example, improved reliability, reduced latency, improved user experience, reduced power consumption, more efficient utilization of computing resources, network resources or both, and improved scalability, among other possibilities.

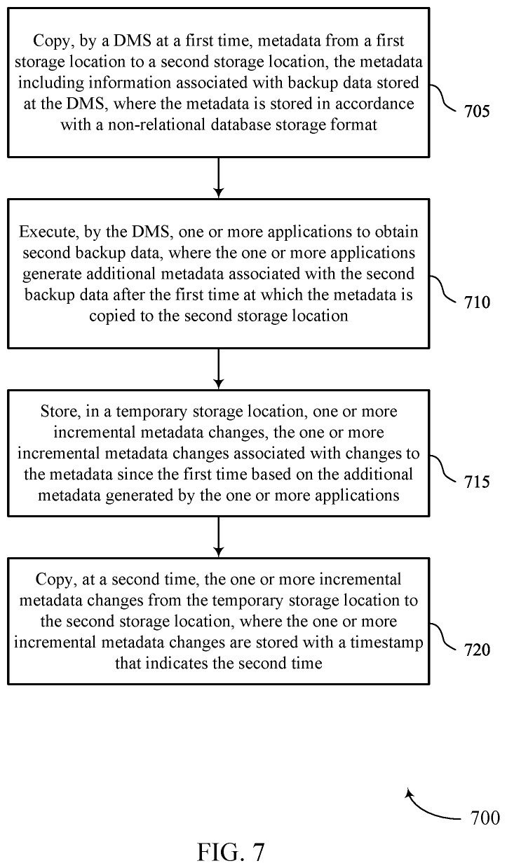

FIG. 7 shows a flowchart illustrating a method 700 that supports backup techniques for non-relational metadata in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include copying, by a DMS at a first time, metadata from a first storage location to a second storage location, the metadata including information associated with backup data stored at the DMS, where the metadata is stored in accordance with a non-relational database storage format. The operations of 705 may be performed in accordance with examples as disclosed herein. In some examples, aspects of the operations of 705 may be performed by a full backup component 525 as described with reference to FIG. 5.

At 710, the method may include executing, by the DMS, one or more applications to obtain second backup data, where the one or more applications generate additional metadata associated with the second backup data after the first time at which the metadata is copied to the second storage location. The operations of 710 may be performed in accordance with examples as disclosed herein. In some examples, aspects of the operations of 710 may be performed by an application execution component 530 as described with reference to FIG. 5.

At 715, the method may include storing, in a temporary storage location, one or more incremental metadata changes, the one or more incremental metadata changes associated with changes to the metadata since the first time based on the additional metadata generated by the one or more applications. The operations of 715 may be performed in accordance with examples as disclosed herein. In some examples, aspects of the operations of 715 may be performed by a temporary storage component 535 as described with reference to FIG. 5.

At 720, the method may include copying, at a second time, the one or more incremental metadata changes from the temporary storage location to the second storage location, where the one or more incremental metadata changes are stored with a timestamp that indicates the second time. The operations of 720 may be performed in accordance with examples as disclosed herein. In some examples, aspects of the operations of 720 may be performed by an incremental backup component 540 as described with reference to FIG. 5.

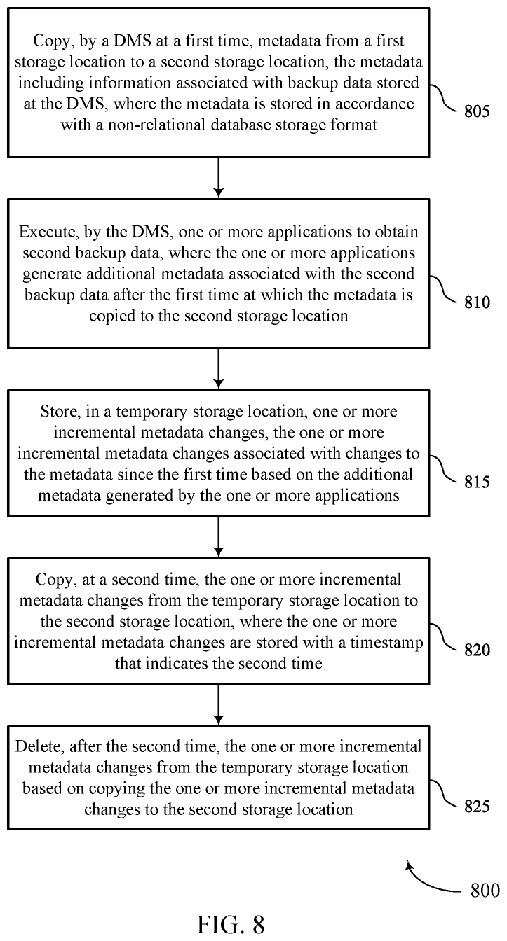

FIG. 8 shows a flowchart illustrating a method 800 that supports backup techniques for non-relational metadata in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include copying, by a DMS at a first time, metadata from a first storage location to a second storage location, the metadata including information associated with backup data stored at the DMS, where the metadata is stored in accordance with a non-relational database storage format. The operations of 805 may be performed in accordance with examples as disclosed herein. In some examples, aspects of the operations of 805 may be performed by a full backup component 525 as described with reference to FIG. 5.

At 810, the method may include executing, by the DMS, one or more applications to obtain second backup data, where the one or more applications generate additional metadata associated with the second backup data after the first time at which the metadata is copied to the second storage location. The operations of 810 may be performed in accordance with examples as disclosed herein. In some examples, aspects of the operations of 810 may be performed by an application execution component 530 as described with reference to FIG. 5.

At 815, the method may include storing, in a temporary storage location, one or more incremental metadata changes, the one or more incremental metadata changes associated with changes to the metadata since the first time based on the additional metadata generated by the one or more applications. The operations of 815 may be performed in accordance with examples as disclosed herein. In some examples, aspects of the operations of 815 may be performed by a temporary storage component 535 as described with reference to FIG. 5.

At 820, the method may include copying, at a second time, the one or more incremental metadata changes from the temporary storage location to the second storage location, where the one or more incremental metadata changes are stored with a timestamp that indicates the second time. The operations of 820 may be performed in accordance with examples as disclosed herein. In some examples, aspects of the operations of 820 may be performed by an incremental backup component 540 as described with reference to FIG. 5.

At 825, the method may include deleting, after the second time, the one or more incremental metadata changes from the temporary storage location based on copying the one or more incremental metadata changes to the second storage location. The operations of 825 may be performed in accordance with examples as disclosed herein. In some examples, aspects of the operations of 825 may be performed by a deletion component 545 as described with reference to FIG. 5.

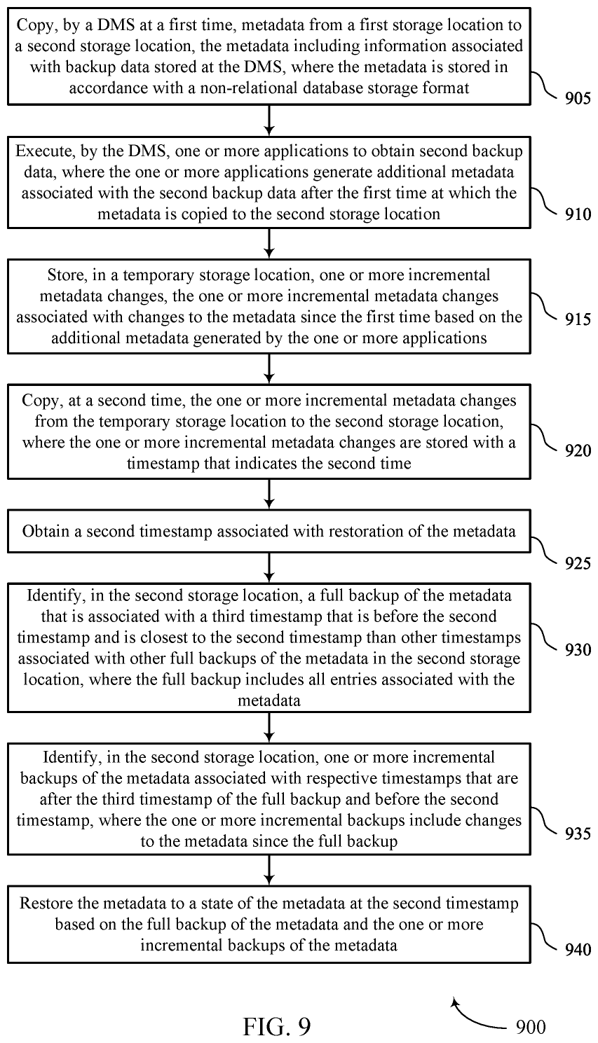

FIG. 9 shows a flowchart illustrating a method 900 that supports backup techniques for non-relational metadata in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include copying, by a DMS at a first time, metadata from a first storage location to a second storage location, the metadata including information associated with backup data stored at the DMS, where the metadata is stored in accordance with a non-relational database storage format. The operations of 905 may be performed in accordance with examples as disclosed herein. In some examples, aspects of the operations of 905 may be performed by a full backup component 525 as described with reference to FIG. 5.

At 910, the method may include executing, by the DMS, one or more applications to obtain second backup data, where the one or more applications generate additional metadata associated with the second backup data after the first time at which the metadata is copied to the second storage location. The operations of 910 may be performed in accordance with examples as disclosed herein. In some examples, aspects of the operations of 910 may be performed by an application execution component 530 as described with reference to FIG. 5.

At 915, the method may include storing, in a temporary storage location, one or more incremental metadata changes, the one or more incremental metadata changes associated with changes to the metadata since the first time based on the additional metadata generated by the one or more applications. The operations of 915 may be performed in accordance with examples as disclosed herein. In some examples, aspects of the operations of 915 may be performed by a temporary storage component 535 as described with reference to FIG. 5.

At 920, the method may include copying, at a second time, the one or more incremental metadata changes from the temporary storage location to the second storage location, where the one or more incremental metadata changes are stored with a timestamp that indicates the second time. The operations of 920 may be performed in accordance with examples as disclosed herein. In some examples, aspects of the operations of 920 may be performed by an incremental backup component 540 as described with reference to FIG. 5.

At 925, the method may include obtaining a second timestamp associated with restoration of the metadata. The operations of 925 may be performed in accordance with examples as disclosed herein. In some examples, aspects of the operations of 925 may be performed by a timestamp component 550 as described with reference to FIG. 5.

At 930, the method may include identifying, in the second storage location, a full backup of the metadata that is associated with a third timestamp that is before the second timestamp and is closest to the second timestamp than other timestamps associated with other full backups of the metadata in the second storage location, where the full backup includes all entries associated with the metadata. The operations of 930 may be performed in accordance with examples as disclosed herein. In some examples, aspects of the operations of 930 may be performed by a metadata restoration component 560 as described with reference to FIG. 5.

At 935, the method may include identifying, in the second storage location, one or more incremental backups of the metadata associated with respective timestamps that are after the third timestamp of the full backup and before the second timestamp, where the one or more incremental backups include changes to the metadata since the full backup. The operations of 935 may be performed in accordance with examples as disclosed herein. In some examples, aspects of the operations of 935 may be performed by a metadata restoration component 560 as described with reference to FIG. 5.

At 940, the method may include restoring the metadata to a state of the metadata at the second timestamp based on the full backup of the metadata and the one or more incremental backups of the metadata. The operations of 940 may be performed in accordance with examples as disclosed herein. In some examples, aspects of the operations of 940 may be performed by a metadata restoration component 560 as described with reference to FIG. 5.

A method by an apparatus is described. The method may include copying, by a DMS at a first time, metadata from a first storage location to a second storage location, the metadata including information associated with backup data stored at the DMS, where the metadata is stored in accordance with a non-relational database storage format, executing, by the DMS, one or more applications to obtain second backup data, where the one or more applications generate additional metadata associated with the second backup data after the first time at which the metadata is copied to the second storage location, storing, in a temporary storage location, one or more incremental metadata changes, the one or more incremental metadata changes associated with changes to the metadata since the first time based on the additional metadata generated by the one or more applications, and copying, at a second time, the one or more incremental metadata changes from the temporary storage location to the second storage location, where the one or more incremental metadata changes are stored with a timestamp that indicates the second time.

An apparatus is described. The apparatus may include one or more memories storing processor executable code, and one or more processors coupled with the one or more memories. The one or more processors may individually or collectively be operable to execute the code to cause the apparatus to copy, by a DMS at a first time, metadata from a first storage location to a second storage location, the metadata including information associated with backup data stored at the DMS, where the metadata is stored in accordance with a non-relational database storage format, execute, by the DMS, one or more applications to obtain second backup data, where the one or more applications generate additional metadata associated with the second backup data after the first time at which the metadata is copied to the second storage location, store, in a temporary storage location, one or more incremental metadata changes, the one or more incremental metadata changes associated with changes to the metadata since the first time based on the additional metadata generated by the one or more applications, and copy, at a second time, the one or more incremental metadata changes from the temporary storage location to the second storage location, where the one or more incremental metadata changes are stored with a timestamp that indicates the second time.

Another apparatus is described. The apparatus may include means for copying, by a DMS at a first time, metadata from a first storage location to a second storage location, the metadata including information associated with backup data stored at the DMS, where the metadata is stored in accordance with a non-relational database storage format, means for executing, by the DMS, one or more applications to obtain second backup data, where the one or more applications generate additional metadata associated with the second backup data after the first time at which the metadata is copied to the second storage location, means for storing, in a temporary storage location, one or more incremental metadata changes, the one or more incremental metadata changes associated with changes to the metadata since the first time based on the additional metadata generated by the one or more applications, and means for copying, at a second time, the one or more incremental metadata changes from the temporary storage location to the second storage location, where the one or more incremental metadata changes are stored with a timestamp that indicates the second time.

A non-transitory computer-readable medium storing code is described. The code may include instructions executable by one or more processors to copy, by a DMS at a first time, metadata from a first storage location to a second storage location, the metadata including information associated with backup data stored at the DMS, where the metadata is stored in accordance with a non-relational database storage format, execute, by the DMS, one or more applications to obtain second backup data, where the one or more applications generate additional metadata associated with the second backup data after the first time at which the metadata is copied to the second storage location, store, in a temporary storage location, one or more incremental metadata changes, the one or more incremental metadata changes associated with changes to the metadata since the first time based on the additional metadata generated by the one or more applications, and copy, at a second time, the one or more incremental metadata changes from the temporary storage location to the second storage location, where the one or more incremental metadata changes are stored with a timestamp that indicates the second time.

Some examples of the method, apparatus, and non-transitory computer-readable medium described herein may further include operations, features, means, or instructions for deleting, after the second time, the one or more incremental metadata changes from the temporary storage location based on copying the one or more incremental metadata changes to the second storage location.

Some examples of the method, apparatus, and non-transitory computer-readable medium described herein may further include operations, features, means, or instructions for storing, in the temporary storage location after the one or more incremental metadata changes may be deleted from the temporary storage location, one or more second incremental metadata changes, the one or more second incremental metadata changes associated with changes to the metadata after the second time and before a third time based on further execution of the one or more applications and copying, at the third time, the one or more second incremental metadata changes from the temporary storage location to the second storage location, where the one or more second incremental metadata changes may be stored with a second timestamp that indicates the third time.

In some examples of the method, apparatus, and non-transitory computer-readable medium described herein, copying the metadata from the first storage location to the second storage location may include operations, features, means, or instructions for obtaining a full backup of the metadata at the first time, where the first time may be based on a first periodicity for full backups of the metadata.

In some examples of the method, apparatus, and non-transitory computer-readable medium described herein, copying the one or more incremental metadata changes from the temporary storage location to the second storage location may include operations, features, means, or instructions for obtaining an incremental backup of the metadata at the second time, where the second time may be based on a second periodicity for incremental backups of the metadata, and where the first periodicity may be greater than the second periodicity.

In some examples of the method, apparatus, and non-transitory computer-readable medium described herein, the full backup of the metadata includes a backup of all entries of a first metadata table in the first storage location at the first time and the method, apparatuses, and non-transitory computer-readable medium may include further operations, features, means, or instructions for obtaining a second full backup of all entries of the first metadata table in the first storage location at a third time.

In some examples of the method, apparatus, and non-transitory computer-readable medium described herein, the full backup of the metadata includes a backup of all entries of a first metadata table in the first storage location at the first time and the method, apparatuses, and non-transitory computer-readable medium may include further operations, features, means, or instructions for obtaining a second full backup of all entries of a second metadata table in the first storage location at the first time and obtaining a second incremental backup of the second metadata table at a third time, where the second incremental backup includes changes to the second metadata table after the first time and before the third time.

Some examples of the method, apparatus, and non-transitory computer-readable medium described herein may further include operations, features, means, or instructions for obtaining, from the first storage location, the additional metadata generated by the one or more applications and a first timestamp associated with the additional metadata, where the timestamp may be based on the first timestamp, calibrating a clock associated with the second storage location based on the first timestamp obtained from the first storage location, and generating, based on the calibrated clock, one or more second timestamps for storage with one or more second incremental metadata changes performed at one or more third times.

Some examples of the method, apparatus, and non-transitory computer-readable medium described herein may further include operations, features, means, or instructions for obtaining a second timestamp associated with restoration of the metadata, identifying, in the second storage location, a full backup of the metadata that may be associated with a third timestamp that may be before the second timestamp and may be closest to the second timestamp than other timestamps associated with other full backups of the metadata in the second storage location, where the full backup includes all entries associated with the metadata, identifying, in the second storage location, one or more incremental backups of the metadata associated with respective timestamps that may be after the third timestamp of the full backup and before the second timestamp, where the one or more incremental backups include changes to the metadata since the full backup, and restoring the metadata to a state of the metadata at the second timestamp based on the full backup of the metadata and the one or more incremental backups of the metadata.

Some examples of the method, apparatus, and non-transitory computer-readable medium described herein may further include operations, features, means, or instructions for executing, by the DMS while storing the one or more incremental metadata changes in the temporary storage location and copying the one or more incremental metadata changes to the second storage location, the one or more applications to obtain the second backup data, where the temporary storage location provides for uninterrupted execution of the one or more applications during metadata backup operations.

In some examples of the method, apparatus, and non-transitory computer-readable medium described herein, the metadata and the one or more incremental metadata changes may be stored in a sorted strings table format in the second storage location, the sorted strings table format indexed by respective timestamps associated with each entry of the sorted strings table format.

In some examples of the method, apparatus, and non-transitory computer-readable medium described herein, the metadata includes non-structured query language metadata.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
copying, by a data management system at a first time and as part of a metadata backup operation, metadata from a first storage location to a second storage location, the metadata comprising information associated with first backup data stored at the data management system, wherein the first backup data comprises a first backup of one or more target computing objects for which the data management system is configured to provide a backup and recovery service, wherein the metadata is generated by one or more applications used to obtain the first backup data, and wherein the metadata is stored in accordance with a non-relational database storage format;
executing, by the data management system, the one or more applications to obtain second backup data, wherein the second backup data comprises a second backup of the one or more target computing objects, and wherein the one or more applications generate additional metadata associated with the second backup data after the first time at which the metadata is copied to the second storage location;
storing, in a temporary storage location, one or more incremental metadata changes, the one or more incremental metadata changes associated with changes to the metadata since the first time based at least in part on the additional metadata generated by the one or more applications; and
copying, at a second time and as part of an incremental metadata backup operation, the one or more incremental metadata changes from the temporary storage location to the second storage location, wherein the one or more incremental metadata changes are stored with a timestamp that indicates the second time at which the one or more incremental metadata changes are copied to the second storage location as part of the incremental metadata backup operation.

2. The method of claim 1, further comprising:
deleting, after the second time, the one or more incremental metadata changes from the temporary storage location based at least in part on copying the one or more incremental metadata changes to the second storage location.

3. The method of claim 2, further comprising:
storing, in the temporary storage location after the one or more incremental metadata changes are deleted from the temporary storage location, one or more second incremental metadata changes, the one or more second incremental metadata changes associated with changes to the metadata after the second time and before a third time based at least in part on further execution of the one or more applications; and
copying, at the third time, the one or more second incremental metadata changes from the temporary storage location to the second storage location, wherein the one or more second incremental metadata changes are stored with a second timestamp that indicates the third time.

4. The method of claim 1, wherein copying the metadata from the first storage location to the second storage location comprises:
obtaining a full backup of the metadata at the first time, wherein the first time is based at least in part on a first periodicity for full backups of the metadata.

5. The method of claim 4, wherein copying the one or more incremental metadata changes from the temporary storage location to the second storage location comprises:
obtaining an incremental backup of the metadata at the second time, wherein the second time is based at least in part on a second periodicity for incremental backups of the metadata, and wherein the first periodicity is greater than the second periodicity.

6. The method of claim 4, wherein the full backup of the metadata comprises a backup of all entries of a first metadata table in the first storage location at the first time, the method further comprising:
obtaining a second full backup of all entries of the first metadata table in the first storage location at a third time.

7. The method of claim 4, wherein the full backup of the metadata comprises a backup of all entries of a first metadata table in the first storage location at the first time, the method further comprising:
obtaining a second full backup of all entries of a second metadata table in the first storage location at the first time; and
obtaining a second incremental backup of the second metadata table at a third time, wherein the second incremental backup comprises changes to the second metadata table after the first time and before the third time.

8. The method of claim 1, further comprising:
obtaining, from the first storage location, the additional metadata generated by the one or more applications and a first timestamp associated with the additional metadata, wherein the timestamp is based at least in part on the first timestamp;
calibrating a clock associated with the second storage location based at least in part on the first timestamp obtained from the first storage location; and
generating, based at least in part on the calibrated clock, one or more second timestamps for storage with one or more second incremental metadata changes performed at one or more third times.

9. The method of claim 1, further comprising:
obtaining a second timestamp associated with restoration of the metadata;
identifying, in the second storage location, a full backup of the metadata that is associated with a third timestamp that is before the second timestamp and is closest to the second timestamp than other timestamps associated with other full backups of the metadata in the second storage location, wherein the full backup comprises all entries associated with the metadata;
identifying, in the second storage location, one or more incremental backups of the metadata associated with respective timestamps that are after the third timestamp of the full backup and before the second timestamp, wherein the one or more incremental backups comprise changes to the metadata since the full backup; and
restoring the metadata to a state of the metadata at the second timestamp based at least in part on the full backup of the metadata and the one or more incremental backups of the metadata.

10. The method of claim 1, further comprising:
executing, by the data management system while storing the one or more incremental metadata changes in the temporary storage location and copying the one or more incremental metadata changes to the second storage location, the one or more applications to obtain the second backup data, wherein the temporary storage location provides for uninterrupted execution of the one or more applications during metadata backup operations.

11. The method of claim 1, wherein the metadata and the one or more incremental metadata changes are stored in a sorted strings table format in the second storage location, the sorted strings table format indexed by respective timestamps associated with each entry of the sorted strings table format.

12. The method of claim 1, wherein the metadata comprises non-structured query language metadata.

13. An apparatus, comprising:
one or more memories storing processor-executable code; and
one or more processors coupled with the one or more memories and individually or collectively operable to execute the code to cause the apparatus to:
copy, by a data management system at a first time and as part of a metadata backup operation, metadata from a first storage location to a second storage location, the metadata comprising information associated with first backup data stored at the data management system, wherein the first backup data comprises a first backup of one or more target computing objects for which the data management system is configured to provide a backup and recovery service, wherein the metadata is generated by one or more applications used to obtain the first backup data, and wherein the metadata is stored in accordance with a non-relational database storage format;
execute, by the data management system, the one or more applications to obtain second backup data, wherein the second backup data comprises a second backup of the one or more target computing objects, and wherein the one or more applications generate additional metadata associated with the second backup data after the first time at which the metadata is copied to the second storage location;
store, in a temporary storage location, one or more incremental metadata changes, the one or more incremental metadata changes associated with changes to the metadata since the first time based at least in part on the additional metadata generated by the one or more applications; and
copy, at a second time and as part of an incremental metadata backup operation, the one or more incremental metadata changes from the temporary storage location to the second storage location, wherein the one or more incremental metadata changes are stored with a timestamp that indicates the second time at which the one or more incremental metadata changes are copied to the second storage location as part of the incremental metadata backup operation.

14. The apparatus of claim 13, wherein the one or more processors are individually or collectively further operable to execute the code to cause the apparatus to:
delete, after the second time, the one or more incremental metadata changes from the temporary storage location based at least in part on copying the one or more incremental metadata changes to the second storage location.

15. The apparatus of claim 14, wherein the one or more processors are individually or collectively further operable to execute the code to cause the apparatus to:
store, in the temporary storage location after the one or more incremental metadata changes are deleted from the temporary storage location, one or more second incremental metadata changes, the one or more second incremental metadata changes associated with changes to the metadata after the second time and before a third time based at least in part on further execution of the one or more applications; and
copy, at the third time, the one or more second incremental metadata changes from the temporary storage location to the second storage location, wherein the one or more second incremental metadata changes are stored with a second timestamp that indicates the third time.

16. The apparatus of claim 13, wherein, to copy the metadata from the first storage location to the second storage location, the one or more processors are individually or collectively operable to execute the code to cause the apparatus to:
obtain a full backup of the metadata at the first time, wherein the first time is based at least in part on a first periodicity for full backups of the metadata.

17. A non-transitory computer-readable medium storing code, the code comprising instructions executable by one or more processors to:
copy, by a data management system at a first time and as part of a metadata backup operation, metadata from a first storage location to a second storage location, the metadata comprising information associated with first backup data stored at the data management system, wherein the first backup data comprises a first backup of one or more target computing objects for which the data management system is configured to provide a backup and recovery service, wherein the metadata is generated by one or more applications used to obtain the first backup data, and wherein the metadata is stored in accordance with a non-relational database storage format;
execute, by the data management system, the one or more applications to obtain second backup data, wherein the second backup data comprises a second backup of the one or more target computing objects, and wherein the one or more applications generate additional metadata associated with the second backup data after the first time at which the metadata is copied to the second storage location;
store, in a temporary storage location, one or more incremental metadata changes, the one or more incremental metadata changes associated with changes to the metadata since the first time based at least in part on the additional metadata generated by the one or more applications; and
copy, at a second time and as part of an incremental metadata backup operation, the one or more incremental metadata changes from the temporary storage location to the second storage location, wherein the one or more incremental metadata changes are stored with a timestamp that indicates the second time at which the one or more incremental metadata changes are copied to the second storage location as part of the incremental metadata backup operation.

18. The non-transitory computer-readable medium of claim 17, wherein the instructions are further executable by the one or more processors to:
delete, after the second time, the one or more incremental metadata changes from the temporary storage location based at least in part on copying the one or more incremental metadata changes to the second storage location.

19. The non-transitory computer-readable medium of claim 18, wherein the instructions are further executable by the one or more processors to:
store, in the temporary storage location after the one or more incremental metadata changes are deleted from the temporary storage location, one or more second incremental metadata changes, the one or more second incremental metadata changes associated with changes to the metadata after the second time and before a third time based at least in part on further execution of the one or more applications; and
copy, at the third time, the one or more second incremental metadata changes from the temporary storage location to the second storage location, wherein the one or more second incremental metadata changes are stored with a second timestamp that indicates the third time.

20. The non-transitory computer-readable medium of claim 17, wherein the instructions to copy the metadata from the first storage location to the second storage location are executable by the one or more processors to:
obtain a full backup of the metadata at the first time, wherein the first time is based at least in part on a first periodicity for full backups of the metadata.
